(19) United States
(12) Patent Application Publication
(10) Pub. No.: US 2008/0277999 A1
(43) Pub. Date: Nov. 13, 2008

(54) Axle assembly of wheel

(75) Inventors: Jae Myoung Song, Gyeongji-city (KR); Hyung Joo Lee, Gyeongjiu-city (KR)

Correspondence Address: LEXYOUME IP GROUP, LLC, 5180 PARKSTONE DRIVE, SUITE 175, CHANTILLY, VA, 20151, US

(73) Assignee: IL JIN GLOBAL CO., LTD., Seoul (KR)

(21) Appl. No.: 12/220,563

(22) Filed: Jul. 25, 2008

Related U.S. Application Data
(63) Continuation of application No. 11/225,118, filed on Sep. 14, 2005, now abandoned.
Application No. 11/225,118 is a continuation of application No. 11/225,075, filed on Sep. 14, 2005, now abandoned.

(30) Foreign Application Priority Data
Feb. 28, 2005 (KR) 10-2005-0016533
Feb. 28, 2005 (KR) 10-2005-0016534

(51) Int. Cl. B60B 35/18

(52) U.S. Cl. 301/132

(57) ABSTRACT

The present invention relates to an axle assembly of a wheel where a hub and a brake disk are integrally formed. An axle assembly of a wheel according to exemplary embodiments of the present invention may include: a wheel bearing assembly provided with a bearing inner shaft having a first inner raceway at an inner side thereof, an inner ring mounted at an outer side of the bearing inner shaft and having a second inner raceway, an outer ring having first and second outer raceways respectively corresponding to the first and second inner raceways and engaged to a knuckle, and bearings disposed between the first and second inner raceways and the first and second outer raceways; a hub for mounting the wheel, the hub being mounted at the outer side of the bearing inner shaft; and a brake disk integrally formed with the hub, wherein the bearing inner shaft is provided with a first stepped surface for mounting the inner ring and a second stepped surface for mounting the hub.

### CROSS-REFERENCE TO RELATED APPLICATIONS

This is a continuation of application Ser. Nos. 11/225,075, filed Sep. 14, 2005, now abandoned and 11/225,118, filed Sep. 14, 2005, now abandoned, the entire contents of which are incorporated herein by reference.

### BACKGROUND OF THE INVENTION

(a) Field of the Invention

The present invention relates to an axle assembly of a wheel. More particularly, the present invention relates to an axle assembly of a wheel where a hub and a brake disk are integrally formed.

(b) Description of the Related Art

Generally, an axle of a vehicle is a portion supporting the weight of the vehicle through a wheel attached thereto, and divided into a driving wheel axle delivering a driving torque generated at an engine and a driven wheel axle not delivering the driving torque.

Furthermore, according to a suspension manner, the axel of the vehicle is divided into an integral type axle combining left and right wheels with one axle and a separate type axle enabling the left and right wheels to work respectively separately. The driving wheel axle serves to deliver a driving torque passed through a transmission and a differential gear from an engine to wheels, and to support the strengths of up and down and left and right directions coming from the road surface, and the front and the rear directions. A front axle of a front-wheel driving vehicle or a rear axle of a rear-wheel driving vehicle corresponds thereto. In addition, the driven wheel axle serves to deliver a driving torque passed through a transmission and a differential gear from an engine to wheels, and to support the strengths of up and down and left and right directions coming from the road surface, and the front and the rear directions. A rear axle of a front-wheel driving vehicle or a front axle of a rear-wheel driving vehicle corresponds thereto.

The axle is connected to a wheel through a hub, and an end portion of the hub is covered with a cover to prevent dust or foreign body from incoming and prevent internal lubrication oil from leaking.

In the meantime, a disc brake of a vehicle is constructed to brake by pressing a brake pad with an oil pressure on both sides of a brake disc rotating with wheels. The disc brake includes a brake disc made of special cast iron and being connected to and rotating with a hub, a caliper made of special cast iron and shaped into a saddle, a coupled of brake cylinders combined in the left and right sides of the caliper, a piston, and a pad mounted to the piston and generating a driving force by friction with the brake disc.

As shown in FIG. 1, a conventional axle assembly includes a hub assembly 10, a brake disk 20, a wheel bearing assembly 30, and a knuckle 40.

The hub assembly 10 includes a hub 12 and a hub bolt 14. The wheel bearing assembly 30 includes a bearing 32, an inner ring 34, an outer ring 36, and a bearing connecting bolt 38.

Hereinafter, the left side in the drawing will be called “outer side” and the right side in the drawing will be called “inner side”.

A hub flange 16 of the hub assembly 10 is combined with the brake disk 20 and a wheel (not shown) to the outer side of a vehicle the hub bolt 14, and coupled with the wheel bearing assembly 30 to the inner side of the vehicle, thereby being coupled with other suspension (not shown) parts, such as the knuckle 40.

While driving of the vehicle, wheels, the brake disc 20, and the hub 12 rotate, and the bearing 32 mounted to the fixed knuckle 40 serves to support the load of the vehicle and makes rotation smooth.

Meanwhile, the brake disc 20 is connected by using the hub bolt 14 to be fixed to the hub flange 16 of the hub 1. Also, said brake disc 20 and the brake disc 20 assembled to the knuckle 40 constitute brake apparatus of the vehicle, and serve to stop the vehicle by the friction resistance between a brake pad (not shown) and a disc (not shown).

Since the conventional axle assembly constructed such above processes the brake disc and a wheel loaded surface on a hub section, there is a disadvantage that cost goes up, assembly man-hours also increase and design freedom gets lowered.

Furthermore, since the management of the axial flow shake of the hub and the brake disc is required to secure the stable brake capacity, there is a problem that the management of general shake is difficult because of the shake accumulated between parts.

In addition, there is a disadvantage that the management of general shake is difficult since a tap hole process for assembly of the brake disc is added, and cost goes up since a process time increases due to addition of process man hours and assembly.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an axle assembly of a wheel having advantages of integrally forming a hub and a brake disk. Other object of the present invention is to provide an axle assembly of a wheel which can simplify the structure of an axle assembly, thereby reducing its weight and saving its cost.

An axle assembly of a wheel according to exemplary embodiments of the present invention may include: a wheel bearing assembly provided with a bearing inner shaft having a first inner raceway at an inner side thereof, an inner ring mounted at an outer side of the bearing inner shaft and having a second inner raceway, an outer ring having first and second outer raceways respectively corresponding to the first and second inner raceways and engaged to a knuckle, and bearings disposed between the first and second inner raceways and the first and second outer raceways; a hub for mounting the wheel, the hub being mounted at the outer side of the bearing inner shaft; and a brake disk integrally formed with the hub, wherein the bearing inner shaft is provided with a first stepped surface for mounting the inner ring and a second stepped surface for mounting the hub.

### BRIEF DESCRIPTION OF THE DRAWINGS

FIG. 1 is a cross-sectional view of an assembly of a brake and a wheel bearing according to the prior art.

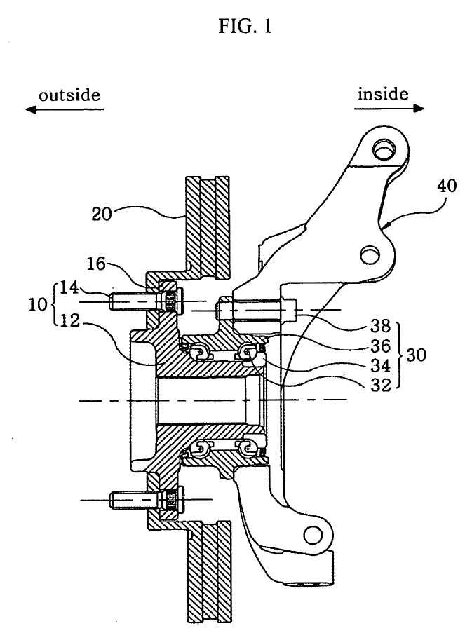

FIG. 2 is a cross-sectional view of an axle assembly of a wheel according to the first exemplary embodiment of the present invention.

FIG. 3 is a front cross-sectional view of the axle assembly of FIG. 2.

FIG. 4 is a cross-sectional view of an axle assembly of a wheel according to the second exemplary embodiment of the present invention.

FIG. 5 is a cross-sectional view of an axle assembly of a wheel according to the third exemplary embodiment of the present invention.

FIG. 6 is a cross-sectional view of an axle assembly of a wheel according to the fourth exemplary embodiment of the present invention.

### DETAILED DESCRIPTION OF THE EMBODIMENTS

Hereinafter, axle assembly of a wheel according to exemplary embodiments of the present invention will be described in detail with reference to the accompanying drawings.

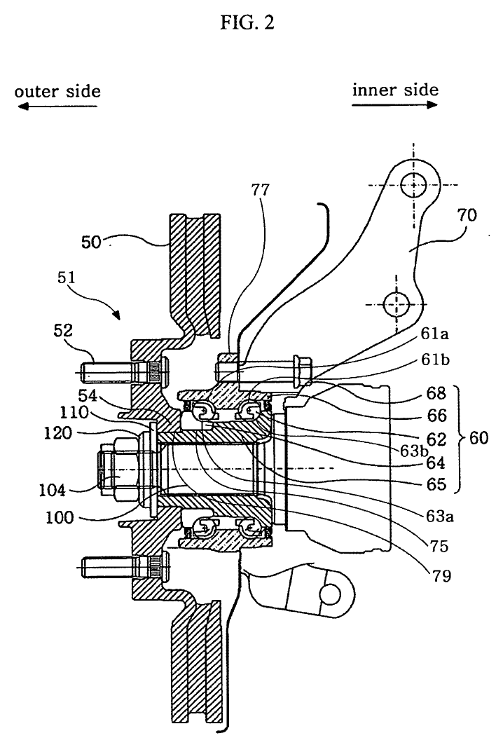

In FIG. 2 and FIG. 4 to FIG. 6, the left side in the drawing will be called “outer side”, and the right side in the drawing will be called “inner side”.

FIG. 2 is a cross-sectional view of an axle assembly of a wheel according to the first exemplary embodiment of the present invention. The first exemplary embodiment of the present invention shows an axle assembly of a wheel where the spirit of the present invention is applied to a driving wheel.

As shown in FIG. 2, an axle assembly of a wheel according to the first exemplary embodiment of the present invention includes a brake disk 50, a hub 51, a wheel bearing assembly 60, and a knuckle 70.

The wheel bearing assembly 60 includes bearings 62, an inner ring 64, a bearing inner shaft 65, an outer ring 66, and a bearing connecting bolt 68.

The bearing inner shaft 65 is mounted on a drive shaft 100 for transmitting driving torque, and is provided with a first inner raceway 63b, a first stepped surface 75, and a second stepped surface 79 sequentially formed therein. Generally, the bearing inner shaft 65 splined to the drive shaft 100.

The inner ring 64 is mounted on the first stepped surface 75 of the bearing inner shaft 65, and is provided with a second inner raceway 63a.

First and second outer raceways 61b and 61a respectively corresponding to the first and second inner raceways 63b and 63a are formed at an interior surface of the outer ring 66, and a flange 77 is protruded radially outwardly at an exterior surface thereof. A bolt hole is formed at the flange 77 such that the wheel bearing assembly 60 is coupled to the knuckle 70 by the bearing connecting bolt 68.

The bearings 62 are disposed in two rows, and are disposed respectively between the first inner raceway 63b and the first outer raceway 61b, and between the second inner raceway 63a and the second outer raceway 61a.

The hub 51 is integrally formed with the brake disk 50. A protrude portion 54 is formed at one end of the hub 51, an inner side of the protrude portion 54 is abutted to the inner ring 64, and an interior surface of the protrude portion 54 is mounted at on the second stepped surface 79 of the bearing inner shaft 65. In addition, a middle portion of the hub 51 is engaged to a wheel (not shown) by a hub bolt 52.

In addition, a screw thread for mounting a nut 104 is formed at an outer side of the drive shaft 100. In order to closely engage the protrude portion 54 with the bearing inner shaft 65, a plane washer 110 and a spring a washer 120 are interposed therebetween and are engaged by the nut 104.

Because the inner ring 64 is mounted on the first stepped surface 75 and the protrude portion 54 of the hub 51 is mounted on the second stepped surface 79, inter-skidding of the wheel assembly to an axial direction may be prevented. In addition, because the inner side of the hub 51 does not apply axial force to the inner ring 64 excessively, deformation generated when the inner ring is mounted may be reduced. Furthermore, because the inner ring 64 is disposed closed to the nut 104, it may be easy to control pre-pressure and distribution of the axial force may be reduced.

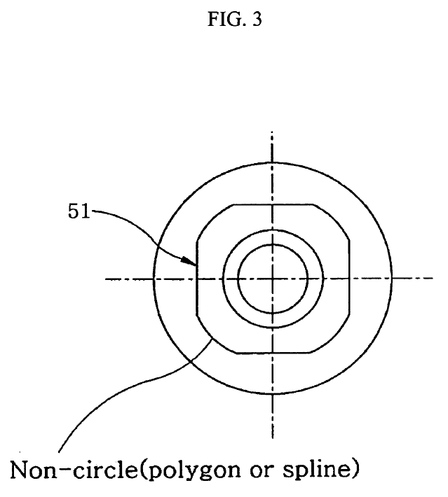

FIG. 3 is a front cross-sectional view of the axle assembly of FIG. 2.

As shown in FIG. 3, a portion of the hub 51 contacting with the wheel bearing assembly 60 is processed to be any one of non-circle, a polygon, and a spline, so as to prevent inter-skidding in the circumferential direction. After the hub 51 is processed to be any one of non-circle, a polygon, and a spline, the axial force is applied to the bearings 62 by the nut 104 or cold forming such that the pre-pressure is applied to the bearing 62 and the hub 51 are combined with the bearing inner shaft 65.

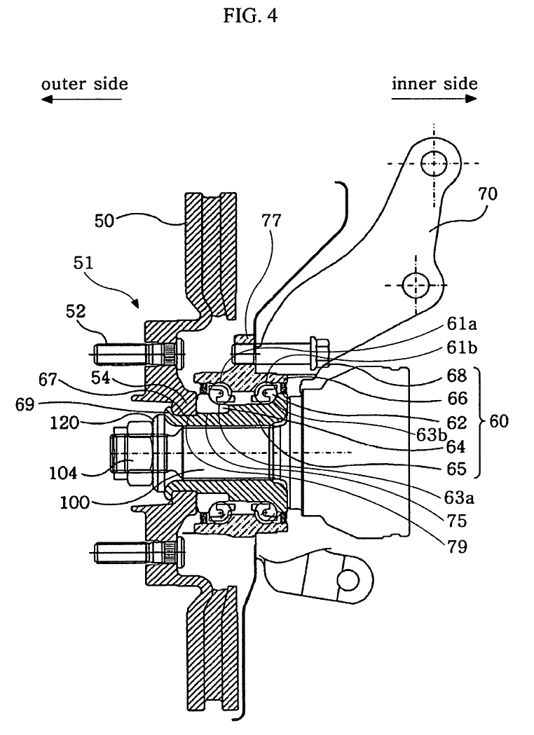

FIG. 4 is a cross-sectional view of an axle assembly of a wheel according to the second exemplary embodiment of the present invention.

Since an axle assembly of a wheel according to the second exemplary embodiment of the present invention is similar to the axle assembly of a wheel according to the first exemplary embodiment of the present invention, the same reference numerals are used for the same constituent elements, and detailed descriptions thereof will be omitted.

The difference between the first and second exemplary embodiments of the present invention is that after the protrude portion 54 of the hub 51 is mounted on the second stepped surface 79 formed at the outer side of the bearing inner shaft 65, an outer end of the bearing inner shaft 65 is cold formed to form a caulking portion 69. In addition, the screw thread for mounting the nut 104 is formed at the outer side of the drive shaft 100. Therefore, the hub 51 is combined with the bearing inner shaft 65 by the nut 104.

In this case, the protrude portion 54 of the hub 51 is inserted into the second stepped surface 79 of the bearing inner shaft 65, and is connected to the bearing inner shaft 65 by cold forming (e.g., forming or swaging). Therefore, a vehicle axle assembly becomes simplified. Thereby, not only the number of parts but also weight and cost may be reduced.

In addition, when combining the drive shaft 100, the outer side of the caulking portion 69 is elastically supported by the spring washer 120.

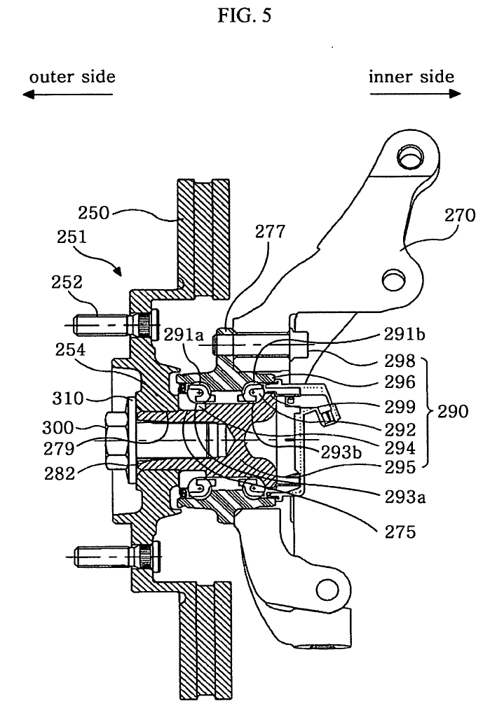

FIG. 5 is a cross-sectional view of an axle assembly of a wheel according to the third exemplary embodiment of the present invention. The third exemplary embodiment of the present invention shows an axle assembly of a wheel where the spirit of the present invention is applied to a driven wheel.

As shown in FIG. 5, an axle assembly of a wheel according to the third exemplary embodiment of the present invention includes a brake disk 250, a hub 251, a wheel bearing assembly 290, and a knuckle 270.

The wheel bearing assembly 290 includes bearings 292, an inner ring 294, a bearing inner shaft 295, an outer ring 296, and a bearing connecting bolt 298.

The bearing inner shaft 295 is provided with a protrusion portion 299, a first inner raceway 293b, a first stepped surface 275, and a second stepped surface 279 sequentially formed therein. The protrusion portion 299 is bent to the outer side of the bearing 292.

The inner ring 294 is mounted on the first stepped surface 275 of the bearing inner shaft 295, and is provided with the second inner raceway 293a.

First and second outer raceways 291b and 291a respectively corresponding to the first and second inner raceways 293b and 293a are formed at the interior surface of the outer ring 296, and a flange 277 is protruded radially outwardly at an exterior surface thereof. A bolt hole is formed at the flange 277 such that the wheel bearing assembly is coupled to the knuckle 270 by the bearing connecting bolt 298.

The bearings 292 are disposed in two rows, and are disposed respectively between the first inner raceway 293b and the first outer raceway 291b, and between the second inner raceway 293a and the second outer raceway 291a.

A tap 282 is formed at an interior circumference of the bearing inner shaft 295. After the hub 251 is assembled, a washer 310 is assembled and fastened by an assembly bolt 300, thereby giving axial force and pre-pressure to the wheel bearing assembly 290.

The hub 251 is integrally formed with the brake disk 250. A protrude portion 254 is formed at one end of the hub 251, the inner side of the protrude portion 254 is abutted to the inner ring 294 of the wheel bearing assembly 290, and an interior surface of the protrude portion 254 is mounted on the second stepped surface 279 of the bearing inner shaft 295. In addition, a middle portion of the hub 251 is engaged to a wheel (not shown) by the hub bolt 252.

Because the inner ring 294 is mounted on the first stepped surface 275 and the protrude portion 254 of the hub 251 is mounted on the second stepped surface 279, inter-skidding of the wheel assembly to an axial direction may be prevented. In addition, because the inner side of the hub 251 does not apply axial force to the inner ring 294 excessively, deformation generated when the inner ring is mounted may be reduced. Furthermore, because the inner ring 294 is disposed closed to the assembly bolt 104, it may be easy to control pre-pressure and distribution of the axial force may be reduced.

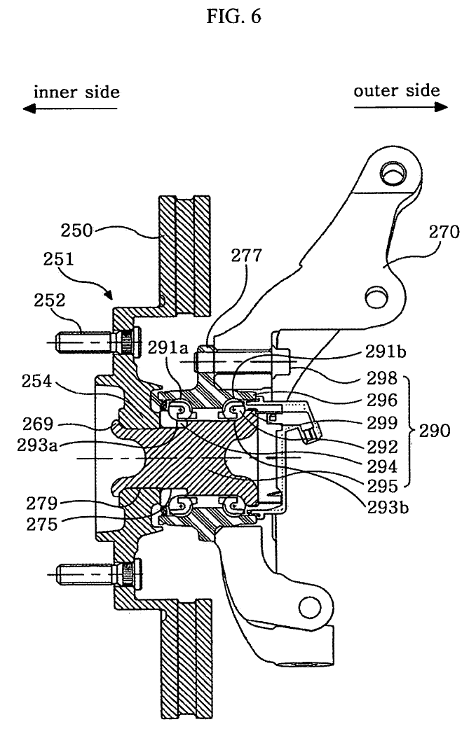

FIG. 6 is a cross-sectional view of an axle assembly of a wheel according to the fourth exemplary embodiment of the present invention.

Since an axle assembly of a wheel according to the fourth exemplary embodiment of the present invention is similar to the axle assembly of a wheel according to the third exemplary embodiment of the present invention, the same reference numerals are used for the same constituent elements, and detailed descriptions thereof will be omitted.

The difference between the third and fourth exemplary embodiments of the present invention is the wheel bearing assembly 290.

After the protrude portion 254 of the hub 251 is inserted into the second stepped surface 279 formed at the outer side of the bearing inner shaft 295, the outer end of the bearing inner shaft 295 is cold formed to form a caulking portion 269. The caulking portion 269 is bent radially ourwardly from the outer side of the bearing inner shaft 295.

In this case, the protrude portion 254 of the hub 251 is inserted into the second stepped surface 279 of the bearing inner shaft 295, and is connected to the bearing inner shaft 295 by cold forming (e.g., forming or swaging). Therefore, a vehicle axle assembly becomes simplified. Thereby, not only the number of parts but also weight and cost may be reduced.

According to the present invention, since the hub is integrally formed with the brake disk, its structure becomes simplified and its weight also reduces. In addition, an assembly operation time gets shortened and cost may be saved since an assembly process becomes simplified.

Furthermore, since stepped surfaces for receiving the inner ring and the hub are provided to the wheel bearing assembly, its durability life span may increase. Also, since it is possible to manage the axial flow shake of the axle assembly easily, the brake capacity may be secured.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An axle assembly of a wheel comprising:
a wheel bearing assembly provided with a bearing inner shaft having a first inner raceway at an inner side thereof, an inner ring mounted at an outer side of the bearing inner shaft and having a second inner raceway, an outer ring having first and second outer raceways respectively corresponding to the first and second inner raceways and engaged to a knuckle, and bearings disposed between the first and second inner raceways and the first and second outer raceways;
a hub for mounting the wheel, the hub being mounted at the outer side of the bearing inner shaft; and
a brake disk integrally formed with the hub,
wherein the bearing inner shaft is provided with a first stepped surface for mounting the inner ring and a second stepped surface for mounting the hub.

2. The axle assembly of claim 1, wherein the first inner raceway and the first and second stepped surfaces are sequentially formed from the inner side to the outer side.

3. The axle assembly of claim 2, wherein a caulking portion bent radially outwardly in order to fix the hub and the inner ring is formed at the inner side end of the bearing inner shaft.

4. The axle assembly of claim 2, further comprising a drive shaft for transmitting driving torque,
wherein the bearing inner shaft is mounted on the drive shaft.

5. The axle assembly of claim 4, wherein a screw thread for mounting a nut is formed at the outer side of the drive shaft.

6. The axle assembly of claim 3, further comprising a drive shaft for transmitting driving torque,
wherein the bearing inner shaft is mounted on the drive shaft.

7. The axle assembly of claim 6, wherein a screw thread for mounting a nut is formed at the outer side of the drive shaft.

8. The axle assembly of claim 3, wherein the caulking portion is formed by forming or swaging.

9. The axle assembly of claim 2, wherein a screw thread for mounting an assembling bolt is formed at an interior circumference of the outer side of the bearing inner shaft.

10. The axle assembly of claim 1, wherein an contacting portion between the hub and the wheel bearing assembly is processed to be any one of non-circle, a polygon, and a spline, so as to prevent inter-skidding.
